(19) United States
(12) Patent Application Publication
(10) Pub. No.: US 2022/0090948 A1
(43) Pub. Date: Mar. 24, 2022

(54) TWO AND THREE-DIMENSIONAL MODEL BASED CORRECTION OF ELBOW TAP FLOW MEASUREMENT

(71) Applicant: Westinghouse Electric Company LLC, Cranberry Township, PA (US)

(72) Inventors: Matthew M. SWARTZ, Claridge, PA (US); John LOJEK, Valencia, PA (US)

(73) Assignee: Westinghouse Electric Company LLC, Cranberry Township, PA (US)

(21) Appl. No.: 17/028,297

(22) Filed: Sep. 22, 2020

(51) Int. Cl. G01F 1/50; G01K 13/02; G21C 17/022; G06F 30/20

(52) U.S. Cl. CPC G01F 1/50; G01K 13/02; G06F 2111/10; G06F 30/20; G01K 2013/026; G21C 17/022

(57) ABSTRACT

A system for determining coolant flow rate in a nuclear reactor primary cooling loop includes a processor and a memory. The memory stores physical measurements of the mechanical components comprising the primary cooling loop. The memory also stores instructions that cause the processor to: receive pressure data from a plurality of pressure sensors in the cooling loop; calculate a model of fluid flow through the primary cooling loop based on the mechanical component measurements; compare the data from the pressure sensors with estimated data from the fluid flow model; and calculate a statistical weighting of the pressure data from the pressure sensors based on the estimated pressure data from the fluid flow model. In another system, the flow rate is determined from a combination of the estimate from the modeled fluid flow with an estimate based on a calorimetric thermal exchange calculation.

### BACKGROUND

### 1. Field of the Invention

This invention relates to a method to use elbow tap flow measurements as an absolute, independent method of measuring nuclear reactor coolant flow.

### 2. Description of the Prior Art

FIG. 1 depicts aspects of a typical pressurized water reactor (PWR) for a nuclear power plant. The PWR may include a containment vessel that houses a reactor that contains the fissile material in fuel rods in a reactor core, along with a heat exchanger. A liquid coolant, such as water, flows through a primary coolant system 100 which may be composed of multiple pipes 110a,b,c or ductwork. The coolant may be pumped into the reactor core via a pump 120 from what may be considered the cold leg of the pipes 110b comprising the primary coolant system 100. The liquid coolant may be used to absorb heat from the fuel rods, thereby cooling the fissile material therein and heating the liquid coolant. The heat released by the fuel rods converts the coolant to steam which exits the reactor through a hot leg of the pipes 110c. The steam in the hot leg is directed through a heat exchanger 130 where the heat from the liquid coolant in the hot leg of the pipes 110c is transferred to a secondary coolant material flowing through ductwork 150 and comprising a secondary coolant system. The secondary coolant material, which may also comprise water, may be converted to steam on receiving the heat energy from the coolant in the primary coolant system 100. The steam in the secondary coolant system may be directed to an electricity generating system, such as a steam powered turbine to generate electricity. Steam from the turbine may passes through a condenser where it is cooled reverts back to liquid phase.

It may be recognized that the flow rate of the primary coolant fluid through the primary coolant system 100 is critical for proper operation of the reactor. The primary coolant flow rate must be sufficient to cool the reactor core to prevent meltdown. The primary coolant flow rate must also be sufficient to allow efficient heat transfer at the heat exchanger 130. Efficient heat transfer can both cool the primary coolant and optimize the conversion of the heat energy of the secondary coolant to steam thereby operating the steam turbine. Therefore, accurate measurements of the primary coolant flow rate is critical for reactor systems operations.

In some aspects, the flow rate of the reactor primary coolant system fluid may be directly determined by using one or more centrifugal flow meters 160 or differential pressure flow sensors 154 to calculate flow based on a fluid pressure drop over an obstruction inserted in the flow path. FIG. 1 illustrates the use of differential pressure sensors 154 that are installed in the primary reactor coolant system 100. The differential pressure sensors 154 may be installed at taps 152 that are introduced in elbow sections 112 of the primary cooling system ductwork 110. Such elbow taps 152 may be spaced at nominally 15° intervals around the elbow sections 112 of the ductwork 110a. Such taps 152 and pressure sensors 154 may be used due to their compactness and ability to accurately monitor relative changes in flow. Typically, elbow tap pressure sensors 154 may comprise three pair of transducers that measure differential pressure across the inner and outer radius of the piping at elbow sections 112 formed in the ductwork-110a at multiple locations. The measured pressure differential may be used to calculate fluid flow at the location of the pressure sensors 154.

For example, as illustrated in FIG. 1, the differential pressure sensors 154 may be installed on piping or ductwork 110a of the reactor primary coolant system 100, especially at locations disposed between the heat exchanger 130 and the reactor coolant pump 120. The taps 152 may be placed at the inner radius and the outer radius of a 90° piping bend or elbow sections 112 of the ductwork 110a. Alternatively, such taps 152 may be installed in piping having a bend radius less than 90°. As shown in FIG. 1, the piping or ductwork 110a of the primary coolant system 100 for a pressurized water reactor may be very compact due to the economics of installing large pressure rated piping within reactor containments. As a result, small profile pressure sensors 154 or centrifugal flow meters 160 may be used for measuring the fluid flow rate through the ductwork 110a of the primary coolant system 100. It should be noted, however, that there are currently no operating pressurized water reactors that credit the use of a centrifugal flow meter 160 with uncertainty below ±4%. Therefore, flow data from such a device is frequently unused for determining the coolant flow through the primary coolant system 100.

Centrifugal flow meters 160 may show measurement inaccuracies due to their small size compared to a typical diameter of the primary coolant ductwork 110a (which may be about 29″ to about 31″ in diameter). Fluid flowing through such ductwork 110a may demonstrate flow inhomogeneity such as vortex flow versus laminar flow, and the location of the flow meters may not account for such flow variability. Alternatively, pressure sensor meters 154 may require calibration for effective absolute flow measurements. Lacking such calibration, the pressure sensors 154 may only provide a relative flow measurement that may possess an accuracy of only about plus or minus 4-6%. Further, the accuracy of the differential pressure measurement may depend on the accurate placement of the sensors within the ductwork 110a. Given the industrial scale of the piping used in the primary coolant system (typically about 29 inches to about 31 inches in diameter), it is difficult to accurately place the sensors at opposing sections in the elbow sections 112 or to have them accurately spaced at 15° intervals; in some cases, the spacing may have a placement error of about plus or minus 5°. Further, the industrial scale of the piping manufacture, along with the industrial welding process, may result in elbow sections 112 having bends either less than or greater than 90° and ductwork 110a having oval or elliptical cross-sections instead of circular. All of these geometric anomalies may reduce the accuracy of the differential pressure measurements by causing vortex flow patterns and other non-linearities in the fluid flow around the differential pressure sensors. The geometric related effects on the fluid flow may result in a measured flow having inaccuracies of about plus or minus 4%.

Alternatively, and more typically, operating pressurized water reactors rely on indirect measurements of the flow of the primary reactor fluid using calorimetric balance calculations of the secondary coolant loop. The calorimetric balance is an energy balance between the primary coolant system and secondary coolant system. The change in energy of the secondary coolant system (ΔEₛ) is determined by taking the mass flow rate of the secondary coolant system (\dot{M}ₛ) times the change in enthalpy (Δh) between the water entering the steam generator (hᵢₙ) and the water leaving the steam generator (hₒᵤₜ). Thus, ΔEₛ=\dot{M}ₛ·Δh in which Δh=hᵢₙ−hₒᵤₜ. The primary coolant loop change in energy (ΔEₚ) is determined by taking the mass flow rate (\dot{M}ᵣ) times the specific heat (Cₚ) times the change in temperature (ΔT) between the water entering the heat exchanger (Tᵢₙ) and the water leaving the heat exchanger (Tₒᵤₜ), or ΔEₚ=\dot{M}ₚ·Cₚ·ΔT wherein (ΔT=Tᵢₙ−Tₒᵤₜ). Equating the primary and secondary energy differences (ΔEₛ=ΔEₚ) allows the primary coolant flow rate to be determined as \dot{M}=\dot{M}ₛ·Δh/Cₚ·ΔT. The uncertainty associated with this method primarily depends on the secondary side instrumentation. For example, the mass flow in the secondary cooling loop may be determined by measuring a pressure difference across a venturi located in the secondary cooling loop. Such a differential pressure measurement may be a source of uncertainty in a mass flow measurement in the secondary cooling loop. Similarly, the mass flow in the primary cooling loop may be determined from a flow measurement obtained from a leading edge centrifugal flow meter 160 in the primary coolant ductwork 110a. Additional measurement uncertainty may occur in this measurement as well. A further potential source of measurement uncertainty may be in the measured temperature differential measured in the primary coolant loop between the steam upstream of the heat exchanger 130 and downstream of the heat exchanger 130. For example, gradients in the hot leg piping 110c and cold leg piping 110b (i.e. hot leg and cold leg streaming) hinder the ability to accurately measure the temperature difference, leading to high measurement uncertainty in the range of 1.5 to 3% for operating pressurized water reactors.

Further, it has been noted at many utilities that the calorimetric flow measurement uncertainty increases over time due to increases in the hot leg temperature gradient resulting from low leakage loading patterns. Low leakage loading patterns result in a change to the core radial power distribution that increases the core exit temperature gradient. In addition, plants with multiple resistance thermal detectors (RTDs) located at different locations within the cold leg of the primary coolant system have reported temperature differences above those considered in the original engineering design. For example the original design basis temperature difference may have been 2 degrees Fahrenheit, while some plants have reported temperature differences of over 3 degrees Fahrenheit. In addition, newer generation pressurized water reactors may have temperature gradients in the hot leg that are significantly greater than earlier generation pressurized water reactors. The difference in the temperature gradient between the hot leg and the cold leg may alter the calorimetric based method for flow measurement. As a result of these various issues, the calorimetric measurement may be accurate only to about plus or minus 3-4° Fahrenheit.

Therefore, it is understood that improvements of the measurement or calculation of the primary coolant flow rate is desirable to address these various inaccuracies both in coolant flow rate and in coolant temperature measurement.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, and abstract as a whole.

As disclosed above, it would be desirable to use the primary coolant system differential pressure measurement data as a main flow indication for the operation of pressurized water reactors. However, the use of such data may only be effective as long as the total measurement uncertainty less than plus or minus 4%.

In one aspect, data from one or more differential pressure sensors may be combined with data generated by a fluid flow model of at least a portion of the piping in the primary coolant system. The fluid flow model may be based on known fluid dynamics and accurate measurements of the piping geometry of the primary coolant system. The data generated by the fluid flow model may be used to correct inaccuracies in the flow calculations derived from the differential pressure sensor measurements.

In another aspect, the data from the fluid flow model and the calculations from the calorimetric heat transfer calculations can both be used to correct inaccuracies of the in the flow calculations derived from the differential pressure sensor measurements. In yet another aspect, the data from the one or more differential pressure sensors may be combined with the data from the fluid flow model in order to correct temperature estimations of the fluid in the secondary coolant system.

### BRIEF DESCRIPTION OF THE DRAWINGS

The characteristics and advantages of the present disclosure may be better understood by reference to the accompanying Figures.

FIG. 1 is a schematic illustration of a section of the primary coolant loop showing exemplary elbow tap installation configurations, according to an aspect of the disclosure.

FIG. 2A is a schematic illustration of a piece of ductwork in a primary coolant loop, according to an aspect of the disclosure.

FIG. 2B is a block diagram of a first aspect of a fluid flow measurement system using computational fluid dynamic modeling, according to an aspect of the disclosure.

FIG. 3 is a block diagram of one example of a computational fluid flow analysis system, according to an aspect of the disclosure.

FIG. 4 is a block diagram a second aspect of a fluid flow measurement system using computational fluid dynamic modeling and calorimetric balance data, according to an aspect of the disclosure.

FIG. 5 is a block diagram of an aspect to more accurately determine a temperature in a secondary cooling loop, according to an aspect of the disclosure.

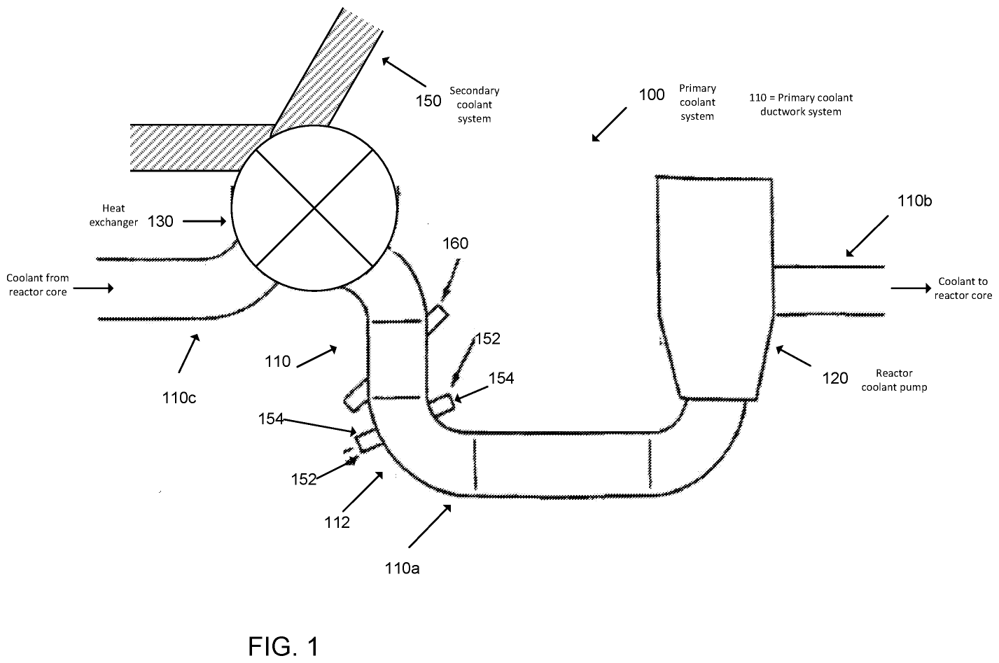

### DETAILED DESCRIPTION

As used herein, the singular form of “a”, “an”, and “the” include the plural references unless the context clearly dictates otherwise. Thus, the articles “a” and “an” are used herein to refer to one or to more than one (i.e., to at least one) of the grammatical object of the article. By way of example, “an element” means one element or more than one element.

In the present application, including the claims, other than where otherwise indicated, all numbers expressing quantities, values or characteristics are to be understood as being modified in all instances by the term “about.” Thus, numbers may be read as if preceded by the word “about” even though the term “about” may not expressly appear with the number. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Further, any numerical range recited herein is intended to include all sub-ranges subsumed therein. For example, a range of “1 to 10” is intended to include any and all sub-ranges between (and including) the recited minimum value of 1 and the recited maximum value of 10, that is, having a minimum value equal to or greater than 1 and a maximum value of equal to or less than 10.

As disclosed above, current methods for determining fluid flow in the primary coolant loop of a pressurized water reactor may have inaccuracies on the order of about 4% or more. Such inaccuracies may result in under or over estimation of the temperature gradient through the primary coolant loop or in the heat exchange and turbine output in the secondary coolant loop. Such inaccuracies may also lead to issues of reactor safety since lack of knowledge of the primary fluid flow may lead to improper cooling of the reactor core. Therefore, it is desirable to develop a system and method to improve the accuracies in determining the fluid flow in the primary cooling loop and/or temperature gradients in the secondary coolant loop. Disclosed below are three aspects associated with improved determinations of fluid flow and temperature exchange technologies to address these issues.

### 1. A First Example of Improved Determination of Primary Loop Fluid Flow

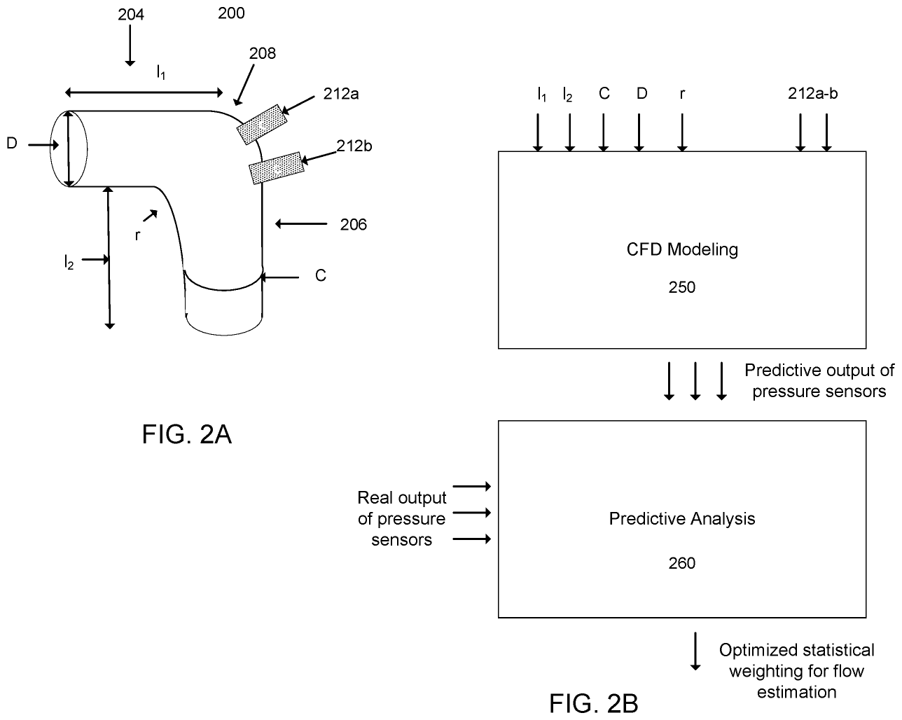

FIG. 2A illustrates a sample piece of ductwork in a primary coolant loop in a PWR reactor. FIG. 2B is a block diagram depicting a first aspect related to an improved method for determining a fluid flow in the primary loop. The method may be based on calculating a fluid flow through a model of at least a portion of the primary cooling loop ductwork. Such a method may include the use of computational fluid dynamics (CFD). A CFD analysis of fluid flow is based on a mathematical model of the physical system through which the flow is being calculated. The dynamics of the fluid flow may be based on well established equations describing the physics of fluid dynamics, including, for example, the Poisson equation and the Navier-Stokes flow equations. A CFD analysis system may include one or more algorithms based on equations related to fluid flow dynamics, a mathematical model of a containment system being analyzed (such as a primary coolant loop in a reactor), parameters characterizing the fluid being modeled, and any required parameters and control logic necessary to apply the algorithms to the containment system model. In use, the CFD analysis system may use the appropriate fluid flow equations along with parameters characterizing the fluid, and calculate a flow of the fluid through the model of the containment system. In some CFD analysis systems, flow vectors of the fluid may be calculated at required locations, such as, without limitation, near the interior surfaces of the containment system, along the center axis of the containment system (distant from the interior surfaces), or at specified locations, such as near the active elements of fluid flow sensors.

Thus, for example, illustrated in FIG. 2A, an exemplary portion of primary cooling loop ductwork 200 may include two relatively straight pipe segments 204 and 206 connected through a bend segment 208. The straight pipe segments 204, 206 may each be characterized by a length, l₁, and l₂, respectively. The bend segment 208 may be characterized by a radius bend, r. The ductwork may also include one or more differential pressure sensors 212a,b which may be used to measure a pressure within the ductwork, especially at the bends. The location of the pressure sensors 212a,b on a bend segment 208 may be defined according to various measurements relative to landmarks on the bend segment 208 (such as welds at either end of the bend segment 208 to a neighboring straight pipe segment 204 or 206).

The ductwork 200 may be further characterized by any number of physical measurements necessary to specify and characterize the layout and geometry of the ductwork 200. Such measurements may include, without limitations, one or more measurements of an inner pipe diameter D, one or more measurements of an outer pipe diameter, and one or more measurements of an inner pipe circumference C. It may be recognized, for example, that operational ductwork 200 defining the primary cooling loop may not be perfectly cylindrical. Thus, a circumference C of a pipe may deviate from being perfectly circular, and the circumference C may change in value and in geometry over a length of the pipe. In some examples, the circumference C of a pipe may be elliptical, ovoid, or otherwise have flattened and/or kinked components.

Additionally, a measured inner diameter D of a pipe may vary depending on how the measurement is made. It may be understood, for example, that the diameter of a perfectly circular cylindrical pipe is invariant regardless of where it is measured with respect to a single plane orthogonal to the longitudinal axis of the cylinder. However, it may be understood that a measurement of a diameter of a non-circular cylindrical pipe may vary depending on where the measurement is made with respect to a single plane orthogonal to the longitudinal axis of the cylinder. For example, a cylindrical pipe having an elliptical cross-section may have multiple diagonal measurements (depending on the orientation of the measurement in the cross-sectional plane) which may range from a length of the major axis of the ellipse to a length of the minor axis of the ellipse. Similar considerations may be made regarding measuring an outer diameter of the pipe.

Further, a bend segment 208 may not be well characterized by a single smooth radius bend r, but may include kinks in the bend. As a result, multiple measurements of the ductwork comprising the primary cooling loop may be required to properly characterize the shape of the interior flow space for the ductwork 200.

In various aspects, the contours of the outer wall of a pipe comprising the ductwork 200 may be measured with a laser scanner. In various aspects, the outer wall thickness of the pipe at the pipe bend segment 208 may be measured with an ultrasonic sensor. Those skilled in the art will recognize that other methods of measuring the contours of the outer wall of a pipe and of measuring the outer wall thickness of the pipe at the pipe bend and elsewhere along the length of the pipe in the primary coolant loop may be used. For example, other methods may include calipers or special tooling fitted with a measuring device.

As illustrated in FIG. 2B, a computational fluid dynamical (CFD) model 250 of the physical geometry of the ductwork 200 in the primary coolant system may thus be created based on all of the physical measurements of the pipes and the locations of the flow and/or pressure sensors, as discussed above. In various aspects, the CFD model 250 may also model possible swirl flow components caused by the reactor coolant pump, upstream and downstream piping geometry, or other multidimensional flow effects.

Additional data that may be included in the CFD flow model 250 may include data that can characterize the fluid flowing through the pipes. Such characteristics may include fluid parameters such as temperature, density, and viscosity. Additionally, the CFD model 250 may include characteristics of the differential pressure measurement devices 212a,b along with their measured localization throughout the ductwork. Such characteristics may be related to the mechanism by which the differential pressure measurement is made, and how that measurements is converted to a flow measurement.

The mathematical model of the ductwork may be used by the CFD model 250 to calculate the flow of the fluid (characterized by its fluid parameters) through the defined ductwork (characterized by the geometric properties of the pipes and bends of the measured primary coolant system). The model of the ductwork may be created based on the physical measurements of the ductwork, as disclosed above. The CFD model 250 may then produce estimates of the data outputs of the differential pressure sensors 212a,b under different simulated flow conditions. The estimates of the pressure sensor outputs can then be related to the liquid flow parameters as calculated by the CFD model 250.

It may be recognized that the accuracy of an algorithm to model the state of a system must be determined in order to rely on the output calculations of the algorithm. In some aspects, the equations used by the CFD model 250, and the manner in which they are applied to any model of a ductwork system, may be applied to one or more benchmarked systems having known flow and pressure characteristics of the fluid therein. Because the flow and pressure characteristics of the benchmarked system are known, characterizing parameters of the CFD model 250 may be adjusted if necessary so that the CFD algorithm produces the results expected for the benchmarked systems. The use of such benchmarking systems to calibrate the CFD model may result in more accurate estimates for the outputs of the pressure sensors 212a,b.

In addition to a CFD model 250, a complete CFD analysis system and method may include a predictive component module 260. Such a predictive component module 260 may be used to compare pressure measurement data obtained from the pressure sensors 212a,b against the outputs from the CFD analysis module under various simulated flow conditions. For example, a first analytical model of a pressure sensor may model the output data of pressure sensor 212a under a variety of flow conditions. Similarly, a second analytical model of a pressure sensor may model the output data of pressure sensor 212b under the same variety of flow conditions. Under operational conditions, the CFD analysis module 250 may receive data from pressure sensor 212a and data from pressure sensor 212b. Such data may be transmitted to the CFD model 250 either wirelessly or via a wired connection, and compared to the first CFD pressure sensor model and second CFD pressure sensor model, respectively. One or more statistical inference algorithms may be used to determine which flow rate, from the CFD flow simulation, is best matched by the actual pressure sensor data of sensors 212a and 212b. A simple transformation of the measured pressure sensor data to fluid flow rate may then be constructed that may include appropriate statistical weighting of the pressure sensor data from the sensors 212a,b. In some instances, statistical weighting may be calculated according to standard methods, for example as disclosed in the ASME PTC 19.1-2013 “Test Uncertainty: Performance Test Code,” the entirety of which is incorporated herein by reference for all purposes.

The use of such modeling, based on the physical layout and characteristics of the primary cooling system, can overcome issues related to the lack of calibration of the sensors and problems of distinguishing random error versus bias in the measurements from the sensors. The use of such a CFD analysis system may be used to improve the accuracy of the flow measurement by reducing the uncertainty of the pressure sensor measurements. As a result, the error in determination of the reactor average temperature may be reduced to less than plus or minus 4%, less than plus or minus 3%, less than plus or minus 2%, and preferably less than plus or minus 1%. In some aspects, the uncertainty of reactor average temperature may be preferably reduced to less than about plus or minus 2-4%.

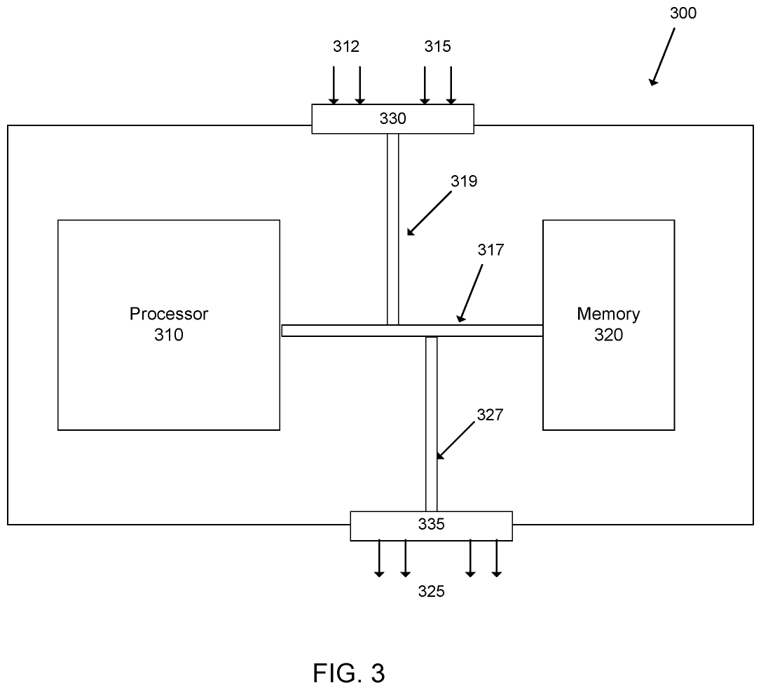

A first example of a CFD analysis system 300 to determine an improved calculation of a primary coolant loop fluid flow may be illustrated in FIG. 3. Thus, the CFD analysis system 300 may be composed of one or more processors 310 and one or more memory components 320. The one or more memory components 320 may include memory circuits configured to store one or more instructions to be acted upon by the one or more processors 310. Such instructions can include, without limitation, instructions related to calculations to implement the fluid dynamics equations which may comprise the CFD analysis module. Additionally, such instructions can include, without limitation, instructions related to calculations made by the predictive component module which may be used to compare pressure measurement data obtained from the pressure sensors against the outputs from the CFD analysis module. The one or more memory components 320 may also include memory circuits configured to store one or more types of data that may be used by the one or more processors 310 for the fluid dynamics equations or for the predictive component module. Such data may be related to characteristics of the coolant fluid, values of mathematical constants, and values to define the structure of the primary coolant loop based on the physical measurements of the ductwork (such as lengths, diameters, and circumferences as disclosed above) as used by the CFD analysis module. Additional data may be related to weighting values for the pressure sensor and flow meter data received by the CFD analysis system 300 and used by the predictive component module. The memory components 320 and one or more processors 310 may communicate date with each other over an electrical bus system 317.

It may be understood that the CFD analysis module and the predictive component modules may be taken as separate modules only in the sense of separate algorithms and mathematical instructions. However, computational and logical instructions for carrying out such software algorithms may be located in the same memory component 320 or in separate memory components 320. Similarly, the same processor 310 may carry out instructions for both the analysis module and predictive component module, or separate processors 310 may carry out the instructions for each of the analysis module and predictive component module.

The CFD analysis system 300 may also include a variety of interfaces such as input interfaces 330 and an output interfaces 335. The input interfaces 330 may include any group of hardware and software protocols necessary to allow the CFD analysis system 300 to receive data from outside of the CFD analysis system 300. Non-limiting examples of such protocols may include any type of parallel electrical interface protocol, any type of serial electrical interface protocol, any type of optical interface protocol, and any type of wireless interface protocol. Thus, in some aspects, the input interfaces 330 may permit the CFD analysis system 300 to receive fluid flow data 312 from one or more pressure sensors or flow sensors disposed within the primary coolant loop. For example, the fluid flow data 312 may be received by one of the input interfaces 330 via a wired serial protocol. Alternatively, the fluid flow data 312 may be received by one of the input interfaces 330 via a wireless protocol. The CFD analysis system 300 may also receive user input data 315 from any type of user input device such as, without limitation, a keyboard, a hand-held pointing device, a mouse, a touch sensitive display screen, a voice input device, or other human input device as is know in the art. The user input data 315 may be used to modify one or more instructions associated with the fluid dynamics calculations, modify numerical data used by the fluid dynamics calculations, or direct the data generated by the CFD analysis system 300 to one or more output devices. The various input data 312 and/or 315 may be directed to the processor 310 and/or the memory components 320 from the input interfaces 330 over an input interface bus 319. In some aspects, the input interface bus 319 may be in data communication with the electrical system bus 317.

The output interfaces 335 may direct output data 325 generated by the CFD analysis system 300 to any appropriate output device. The output interfaces 335 may include any group of hardware and software protocols necessary to allow the CFD analysis system 300 to transmit data outside of the CFD analysis system 300. Such data may originate from the memory components 320, the one or more processors 310, or data received from the input interfaces 330. Non-limiting examples of such protocols may include any type of parallel electrical interface protocol, any type of serial electrical interface protocol, any type of optical interface protocol, and any type of wireless interface protocol. Devices to receive the data may be any one or more of optical display devices, audio devices, or devices configured to receive wireless data from the CFD analysis system 300. The various output data 325 may be directed from the one or more processors 310 and/or the memory components 320 to the output interfaces 335 over an output interface bus 327. In some aspects, the output interface bus 327 may be in data communication with the electrical system bus 317.

### 2. A Second Example of Improved Determination of Primary Loop Fluid Flow

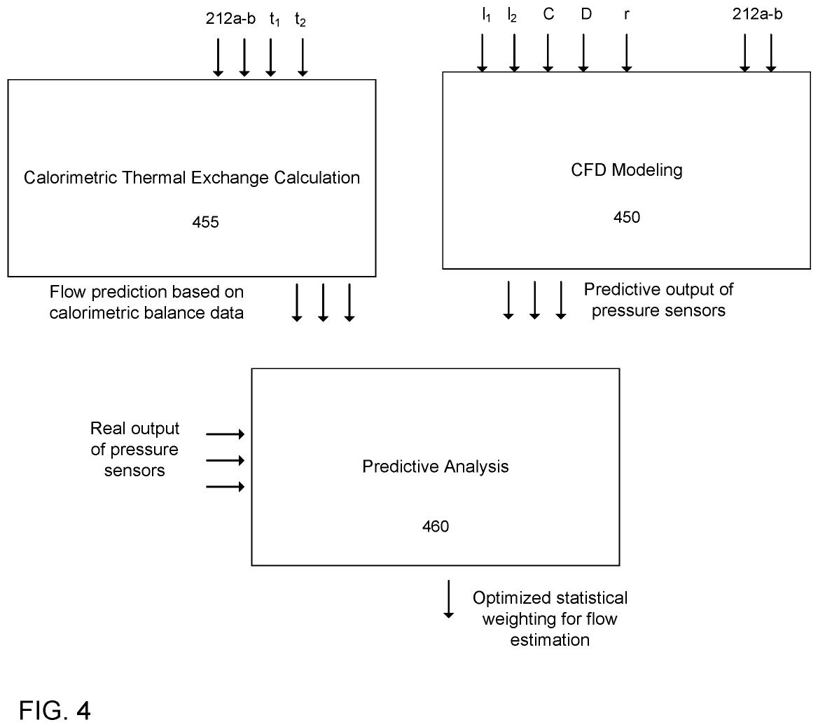

FIG. 4 depicts a second example of a system to determiner fluid flow characteristics through the primary coolant loop of a pressurized water reactor. Such a system may incorporates the CFD analysis system disclosed with respect to FIG. 2B along with the data for determining the fluid flow based on calorimetric mass-flow calculations.

FIG. 4 includes the CFD modeling module 450 similar to that disclosed in FIG. 2B. The model may include physical parameters that define the geometry of the primary cooling ductwork, as illustrated in FIG. 2A. As in FIG. 2B, the parameters may include, without limitations, one or more measurements of pipe inner diameters, one or more measurements of pipe outer diameters, and one of more measurements of pipe circumferences. Additional parameters may be related to the lengths of pipe segments, and radii of curvature of curved or angled portions of the ductwork. Further, parameters related to the location of one or more differential pressure measurement sensors and/or centrifugal flow meters and their operational characteristics may be included in the CFD model 450. The algorithms related to the physics of fluid flow in the ductwork as applied by the CFD modeling module 450 may also be benchmarked against a known system as disclosed above with respect to the system disclosed in FIGS. 2A and 2B.

FIG. 4 also introduces a calorimetric thermal exchange module 455 to calculate the flow of the coolant through the primary coolant loop based on the mass exchange calculations disclosed above. The calorimetric exchange module 455 may receive temperature data from multiple temperature sensors disposed in the primary coolant loop especially upstream and downstream of the heat exchanger. Such temperature sensors may permit the calorimetric exchange module 455 to determine the temperature change in the coolant fluid as it exchanges heat with the secondary coolant fluid in the secondary coolant loop. Additionally, the calorimetric thermal exchange module 455 may also receive pressure data from the one or more pressure sensors in the primary coolant loop. The calorimetric exchange module 455 may use the temperature and pressure data to determine the enthalpy of the steam in the primary cooling loop. In some aspects, the enthalpy determination may be based on known thermodynamic equations and constants associated with the cooling fluid (for example, the specific heat of water). In some other aspects, the enthalpy determination may be based on known tabulated values for the cooling fluid (for example, enthalpy look-up tables based on published data by the American Society of Mechanical Engineers or other authoritative source).

Similar to the improved method for determining fluid flow in the primary cooling loop in a nuclear reactor, as depicted in FIG. 2B, the second example depicted in FIG. 4 may also include a predictive analysis model 460. In this case the predictive analysis module 460 in FIG. 4 may merge the data from the CFD modeling module 450 along with the estimates from the calorimetric thermal exchange module 455 with the real-time data from the differential pressure sensors. Thus, one or more statistical inference algorithms may be used to determine which flow rate from a combination of the CFD flow simulation and the calorimetric estimate, which is best matched by the actual pressure sensor data of sensors. A simple transformation of the measured pressure sensor data to fluid flow rate may then be constructed that may include appropriate statistical weighting of the pressure sensor data from the sensors. It may be understood that the predictive analysis module 460 depicted in FIG. 4 may include additional algorithms to determine a statistical weighting of the data from the plurality of pressure sensors.

It may be recognized that a system for calculating an improved measure of the fluid flow through the primary cooling loop of a nuclear reactor based on a combination of a CFD model of the ductwork, the calorimetric exchange estimate, and the data obtained from the differential pressure sensors, may be realized in a system similar to that disclosed above and illustrated in FIG. 3. Thus, the data input interface 330 may obtain data from the multiple differential pressure sensors and temperature sensors. The one or more memory components 320 may include memory circuits configured to store one or more instructions to be acted upon by the one or more processors 310. The memory components 320 may include instructions for calculating the CFD fluid flow model of the ductwork as discussed above with respect to FIGS. 2A and 2B. The memory components 320 may also include instructions for calculating the estimate of the fluid flow based on the calorimetric exchange equations and the data received from the temperature and pressure sensors. The instructions associated with the predictive analysis module, illustrated in FIG. 4, may also be stored in the memory components 320 and determine the optimal statistical weighting of the data from the differential pressure sensors to provide the best statistical estimate of the fluid flow.

### 3. An Example of Improved Determination of Secondary Loop Fluid Temperature

As disclosed above, it is reasonable to improve the determination of the fluid flow in the primary cooling loop in a nuclear reactor. Such information can be used to improve monitoring of the safety of the reactor and assure that the primary cooling fluid is properly absorbing heat from the reactor core and transferring it to the secondary cooling loop for electricity production. It is also useful to have an accurate determination of the temperature of the secondary coolant fluid. Changes in the temperature of the secondary coolant temperature may have an impact of the efficiency of electricity generations in the steam turbine. It maybe recognized that a decrease in the temperature of the secondary coolant steam may decrease the amount of energy generated by a steam turbine due to efficiency losses. Alternatively, if the temperature of the secondary coolant steam increases, the increased temperature may have a negative impact on the ductwork and the steam turbine in the secondary coolant system due to thermal induced mechanical aging of the physical structures. Therefore, it is useful to have an accurate knowledge of the temperature of the steam generated in the secondary coolant loop for both safety and power conversion reasons.

From the mass transfer equations disclosed above, it is recognized that as \dot{M}ₚ=\dot{M}ₛ·Δh/Cₚ·ΔT. This equation permits a determination of the fluid flow in the primary cooling system. However, the equation may be recast as (ΔT)·\dot{M}ₚ/\dot{M}ₛ=Δh/Cₚ. In this equation, Δh/Cₚ corresponds to the temperature change in the secondary cooling loop. Therefore, if the mass transfer of the coolant in the primary cooling loop (the fluid flow) is known or accurately modeled, the temperature difference in the secondary cooling loop may then be estimated.

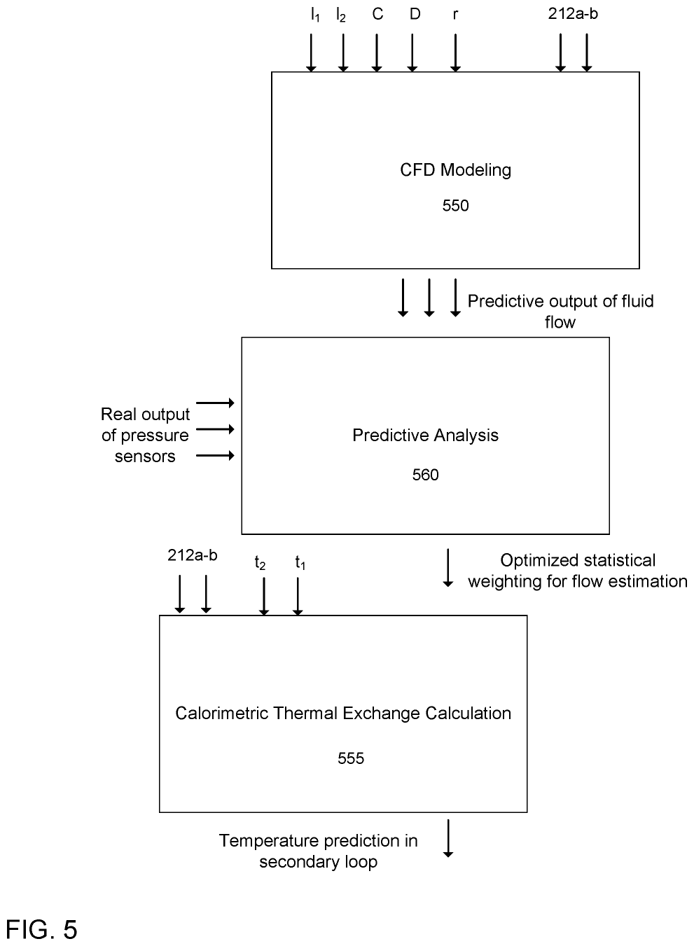

FIG. 5 illustrates a system that may be used to determine more accurately the temperature in the secondary cooling loop. FIG. 5 begins with the CFD modeling module 550, and the predictive flow analysis module 560 as depicted in FIG. 2B. It may be understood that the components and calculations disclosed above with respect to the CFD model 250 and the predictive analysis 260 of the fluid flow in the primary cooling loop are similar to those depicted in FIG. 5 (reference numbers 550 and 560, respectively). The output of the predictive analysis module 560 may provide an improved estimate of the fluid flow in the primary cooling loop. This more accurate determination of the primary coolant flow may be used by the calorimetric thermal exchange calculations 555, along with the temperature data from the primary cooling loop, to calculate an improved temperature difference in the secondary cooling loop.

It may be recognized that a system for calculating an improved measure of the coolant temperature in the secondary cooling loop of a nuclear reactor based on a combination of a CFD model 550 of the ductwork, the calorimetric exchange estimate 560, and the data obtained from the differential pressure sensors, may be realized in a system similar to that disclosed above and illustrated in FIG. 3. Thus, the data input interface 330 may obtain data from the multiple differential pressure sensors and temperature sensors. The one or more memory components 320 may include memory circuits configured to store one or more instructions to be acted upon by the one or more processors 310. The memory components 320 may include instructions for calculating the CFD fluid flow model 550 of the ductwork as discussed above with respect to FIG. 2B. Such instructions can include, without limitation, instructions related to calculations to implement the fluid dynamics equations which may comprise the CFD analysis module. Additionally, such instructions can include, without limitation, instructions related to calculations made by the predictive component module 560 which may be used to compare pressure measurement data obtained from the pressure sensors against the outputs from the CFD analysis module. The memory components 320 may also include instructions for calculating the estimate of the secondary cooling loop temperature based on the calorimetric exchange equations, and the data received from the temperature sensors, the improved estimate of the primary cooling system flow, and the pressure sensors.

While various details have been set forth in the foregoing description, it will be appreciated that the various aspects of devices and techniques for controlling the operation of a transducer may be practiced without these specific details. One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Further, while several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

For conciseness and clarity of disclosure, selected aspects of the foregoing disclosure have been depicted in block diagram form rather than in detail. Some portions of the detailed descriptions provided herein may be presented in terms of instructions that operate on data that is stored in one or more computer memories or one or more data storage devices (e.g. floppy disk, hard disk drive, Compact Disc (CD), Digital Video Disk (DVD), or digital tape). Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

Unless specifically stated otherwise as apparent from the foregoing disclosure, it is appreciated that, throughout the foregoing disclosure, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. In one form, several portions of the subject matter described herein may be implemented via an application specific integrated circuits (ASIC), a field programmable gate array (FPGA), a digital signal processor (DSP), or other integrated formats. However, those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In some instances, one or more elements may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other. It is to be understood that depicted architectures of different components contained within, or connected with, different other components are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated also can be viewed as being “operably connected,” or “operably coupled,” to each other to achieve the desired functionality, and any two components capable of being so associated also can be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components, and/or electrically interacting components, and/or electrically interactable components, and/or optically interacting components, and/or optically interactable components.

In other instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present disclosure have been depicted and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “one form,” or “a form” means that a particular feature, structure, or characteristic described in connection with the aspect is included in at least one aspect. Thus, appearances of the phrases “in one aspect,” “in an aspect,” “in one form,” or “in an form” in various places throughout the specification are not necessarily all referring to the same aspect. Furthermore, the particular features, structures or characteristics may be combined in any suitable manner in one or more aspects.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

All of the above-mentioned U.S. patents, U.S. patent application publications, U.S. patent applications, foreign patents, foreign patent applications, non-patent publications referred to in this specification and/or listed in any Application Data Sheet, or any other disclosure material are incorporated herein by reference, to the extent not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A system for determining a coolant fluid flow rate in a primary cooling loop of a nuclear reactor, the system comprising:
a processor unit; and
a memory component,
wherein the memory component is configured to store primary cooling loop physical data defining one or more measurements of mechanical components of at least a portion of the primary cooling loop, and
wherein the memory component is configured to store one or more instructions that, when executed by the processor unit, causes the processor unit to:
receive pressure data from a plurality of differential pressure sensors disposed within the primary cooling loop;
calculate a model of a fluid flow through the mechanical components of the at least portion of the primary cooling loop based at least in part on the primary cooling loop physical data;
compare the pressure data from the plurality of differential pressure sensors with estimated pressure data derived from the model of the fluid flow rate through the mechanical components of the at least portion of the primary cooling loop; and
calculate a statistical weighting of the pressure data from the plurality of differential pressure sensors based on the estimated pressure data derived from the model of the fluid flow rate.

2. The system of claim 1, wherein the instructions, that when executed by the processor unit cause the processor unit to calculate a model of a fluid flow through the mechanical components of the at least portion of the primary cooling loop, comprise algorithmic instructions for calculating a computational fluid flow dynamics model of the at least portion of the primary cooling loop.

3. The system of claim 2, wherein the algorithmic instructions for calculating a computational fluid flow dynamics model are benchmarked against a sample primary cooling loop having known physical parameters and measured fluid flow.

4. The system of claim 1, wherein the primary cooling loop physical data comprise one or more of:
a measurement of a length of at least one portion of duct work comprising the at least portion of the primary cooling loop;
at least one measurement of an inner diameter of the at least one portion of the duct work comprising the at least portion of the primary cooling loop;
at least one measurement of an outer diameter of the at least one portion of the duct work comprising the at least portion of the primary cooling loop;
at least one measurement of a circumference of the at least one portion of the duct work comprising the at least portion of the primary cooling loop; and
at least one measurement of a radius bend of at least one non-linear portion of the duct work comprising the at least portion of the primary cooling loop.

5. The system of claim 4, wherein the physical data comprise measurements of the at least one portion of duct work comprising the at least portion of the primary cooling loop measured by one or more of a laser scanner or an ultrasonic sensor.

6. The system of claim 4, wherein the non-linear portion of the duct work comprises an elbow having a radius bend of about 90°.

7. The system of claim 1, wherein the physical data comprise data associated with one or more of the plurality of differential pressure sensors.

8. The system of claim 7, wherein the data associated with one or more of the plurality of differential pressure sensors comprises a location in the at least portion of the primary cooling loop of the one or more of the plurality of differential pressure sensors.

9. The system of claim 8, wherein the data associated with the location in the at least portion of the primary cooling loop of the one or more of the plurality of differential pressure sensors comprises one or more of a radial positioning on a non-linear portion of the primary cooling loop.

10. The system of claim 1, further comprising one or more input interfaces and one or more output interfaces.

11. The system of claim 10, wherein the one or more input interfaces is configured to receive the pressure data from the plurality of differential pressure sensors.

12. The system of claim 10, wherein the one or more input interfaces is configured to receive the primary cooling loop physical data from a device operated by a user.

13. The system of claim 10, wherein the output interfaces are in data communication with one or more display devices configured to display one or more data associated with the model of the fluid flow and the statistical weighting of the pressure data.

14.-18. (canceled)
